(19) United States
(12) Patent Application Publication
(10) Pub. No.: US 2022/0091716 A1
(43) Pub. Date: Mar. 24, 2022

(54) EXTERNAL CONTENT CAPTURE FOR VISUAL MAPPING METHODS AND SYSTEMS

(71) Applicant: COREL CORPORATION, OTTAWA (CA)

(72) Inventors: MARIAN KOCMANEK, ZEPHYR COVE, NV (US); SIA BANIHASHEMI, DANVILLE, CA (US); MICHAEL DEUTCH, LAS VEGAS, NV (US); BLAIR YOUNG, KANATA (CA)

(21) Appl. No.: 17/480,285

(22) Filed: Sep. 21, 2021

Related U.S. Application Data
(60) Provisional application No. 63/080,853, filed on Sep. 21, 2020.

(51) Int. Cl. G06F 3/0486; G06F 3/0482; G06F 9/451

(52) U.S. Cl. CPC G06F 3/0486; G06F 9/451; G06F 3/0482

(57) ABSTRACT

Mind maps are diagrams used to visually organize information across a wide range of applications. If, a user is not within the mind mapping software application and has an idea or sees an item of content, e.g. an image, a webpage, a website, social media, etc., then they must remember it, jot it down, or generate an electronic message to themselves within another software application. Accordingly, the invention provides users with the means to capture the idea or item of electronic content within a software application or web browser plug-in, for example, such that the idea of item of electronic content is automatically rendered either within the mind mapping software application generally or upon their opening a specific a mind map. This capturing of content can be solely for the user themselves or they can provide to collaborators as well receive content from collaborators for inclusion within their mind maps.

### CROSS-REFERENCE TO RELATED APPLICATIONS

The patent application claims the benefit of priority to U.S. Provisional Patent application 63/080,853 filed Sep. 21, 2020; the entire contents of which are incorporated herein by reference.

### FIELD OF THE INVENTION

This patent application relates to electronic content and more particularly to the acquisition of electronic content at any point in time from any digital source and its insertion into a visual mind map.

### BACKGROUND OF THE INVENTION

Mind maps are diagrams used to visually organize information across a wide range of applications. A mind map is hierarchical and shows relationships between the different elements of the mind map. However, each element must be added to the mind map and associated with the other elements within the mind map. If, a user is not within the mind mapping software application and has an idea or sees an item of electronic content, e.g. an image, a webpage, a website, post, Tweet, etc., which they think should be added as an item to a mind map they must remember it, jot it down, or generate an electronic message to themselves within another software application.

This leads to items being forgotten, lost, etc. Accordingly, it would be beneficial to provide the user with a means to capture the idea or item of electronic content within a software application or web browser plug-in, for example, such that the idea of item of electronic content is automatically rendered to them associated with the mind map within the mind mapping software. It would be further beneficial for other users to be able to capture such items of electronic content which are then rendered to a user within the mind mapping software application. It would be also beneficial for a user to have collaborators providing them items of electronic content where these other users simply providing this to the user, are members of a team with the user or member of a group with the user. It would be also beneficial for the rendered items of content in some instances to be visible to only that user for that mind map or in other instances to other users of that mind map who are part of a team or group with the user.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to electronic content and more particularly to the acquisition of electronic content at any point in time from any digital source and its insertion into a visual mind map.

In accordance with an embodiment of the invention there is provided a method comprising adding an item of electronic content to a mind map, wherein the item of electronic content was acquired within another software application to a mind mapping software application which renders the mind map and supports the addition of the item of content to the mind map.

In accordance with an embodiment of the invention there is provided a method comprising:
providing a first computer system coupled to a communications network comprising a first microprocessor, the first microprocessor executing first code stored within a first memory to provide a first user with a first software application rendering first graphical user interfaces (GUIs) to the user and accepting user input via first haptic interfaces of the first computer system;
providing a second computer system coupled to the communications network comprising a second microprocessor, the second microprocessor executing second code stored within a second memory to provide a second user with a second software application rendering second graphical user interfaces (GUIs) to the user and accepting user input via second haptic interfaces of the second computer system;
receiving upon the first computer system first inputs from the first user via the first haptic interfaces relating to accessing the first software application;
rendering upon the first computer system a first GUI comprising a plurality of fields;
receiving upon the first computer system second inputs from the first user via the first haptic interfaces relating to identifying a type of electronic content within a first field of the plurality of fields;
receiving upon the first computer system third inputs from the first user via the first haptic interfaces relating to the selection of an item of electronic content rendered to the user within a third GUI associated with a third software application;
associating the item of electronic content with a second field of the plurality of fields in dependence upon the type of electronic content;
receiving upon the first computer system fourth inputs from the first user via the first haptic interfaces relating to additional data to be transmitted with the item of content;
associating the additional data within one or more third fields of the plurality of fields;
combining the type of electronic content, the item of electronic content and the additional data together as a mind map item;
transmitting to a third memory accessible to the first computer system;
receiving upon the second computer system fifth inputs from the second user via the second haptic interfaces relating to accessing the second software application;
rendering to the second user upon the second computer system a second GUI comprising a first portion for rendering a mind map selected by the second user and a second portion comprising the mind map item;
receiving upon the second computer system sixth inputs from the second user via the second haptic interfaces relating to selection of the mind map item;
receiving upon the second computer system seventh inputs from the second user via the second haptic interfaces relating to movement of a cursor rendered to the user within first portion of the second GUI selection to which the mind map item is linked;
receiving upon the second computer system eighth inputs from the second user via the second haptic interfaces relating to the cursor within the first portion of the second GUI releasing the mind map item at a user defined position;
adding the item of content to the mind map rendered within the first portion of the second GUI in dependence upon the user defined position within the mind map and the application of a subset of a plurality of rules of the mind mapping software application.

In accordance with an embodiment of the invention there is provided a method comprising:
acquiring electronic content within a first software application upon a first electronic device by a first user;
transmitting the electronic content to a remote server;
opening a mind mapping application upon a second electronic device by a second user; wherein opening the mind mapping software application comprises:
   retrieving and rendering the electronic content; and
   opening a mind map; and
the rendered electronic content can be dragged and dropped within the mind map to place the electronic content within the mind map.

In accordance with an embodiment of the invention there is provided a method comprising:
adding an acquired item of electronic content within a mind map within a mind mapping application opened by a first user upon a first electronic device; wherein
the item of electronic content was acquired with a software application by a second user upon a second electronic device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary electronic device and network supporting embodiments of the invention;

FIG. 2A depicts an exemplary block diagram of a system for a user to acquire and exploit acquired content within a mind mapping application on a mobile client and/or a client device with a remote system according to embodiments of the invention;

FIG. 2B depicts an exemplary block diagram of a system wherein multiple users can acquire content which is provided to a user, team or group allowing them to one or more user and exploit acquired content within a mind mapping application on mobile clients and/or client devices with a remote system according to embodiments of the invention;

FIGS. 3 and 4 depict exemplary mind maps as provided by a mind mapping software application according to the prior art;

FIGS. 5 to 8 depict exemplary graphical user interfaces (GUIs) for the insertion of electronic content from a queue into a visual mind map rendered to a user through a mind mapping software application according to an embodiment of the invention;

FIG. 9 depicts an exemplary GUI for the insertion of electronic content from a queue into a mind map template rendered to a user through a mind mapping software application according to an embodiment of the invention;

FIGS. 10 and 11 depict exemplary GUIs for the acquisition of electronic content within a web browser according to an embodiment of the invention; and

FIG. 12 depicts an exemplary GUI for the acquisition of electronic content within a web browser through an extension of the web browser according to an embodiment of the invention.

### DETAILED DESCRIPTION

The present description is directed to electronic content and more particularly to the acquisition of electronic content at any point in time from any digital source and its insertion into a visual mind map.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers, or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein may refer to, but is not limited to, a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, and an electronic reader.

A “fixed electronic device” (FED) as used herein may refer to, but is not limited to, a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” or “wearable sensor” (Wearable Device) as used herein may refer to, but is not limited to, an electronic device that is worn by a user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

A “client device” as used herein may refer to, but is not limited to, a PED, FED or Wearable Device upon which a user can access directly a file or files which are stored locally upon the PED, FED or Wearable Device, which are referred to as “local files”, and/or a file or files which are stored remotely to the PED, FED or Wearable Device, which are referred to as “remote files”, and accessed through one or more network connections or interfaces to a storage device.

A “server” as used herein may refer to, but is not limited to, one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

A “software application” (commonly referred to as an “application” or “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “graphical user interface” (GUI) as used herein may refer to, but is not limited to, a form of user interface for a PED, FED, Wearable Device, software application or operating system which allows a user to interact through graphical icons with or without an audio indicator for the selection of features, actions, etc. rather than a text-based user interface, a typed command label or text navigation.

An “enterprise” as used herein may refer to, but is not limited to, a provider of a service and/or a product to a user, customer, or consumer and may include, but is not limited to, a retailer, an online retailer, a market, an online marketplace, a manufacturer, a utility, a Government organization, a service provider, and a third party service provider.

A “service provider” as used herein may refer to, but is not limited to, a provider of a service and/or a product to an enterprise and/or individual and/or group of individuals and/or a device comprising a microprocessor.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of organizations, men, and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, web site, software plug-in, software application, and graphical user interface.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed, or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein may refer to, but is not limited to, a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider etc.

A “computer file” (commonly known as a file) as used herein may refer to, but is not limited to, a computer resource for recording data discretely in a computer storage device, this data being electronic content. A file may be defined by one of different types of computer files, designed for different purposes. A file can be opened, read, modified, copied, and closed with one or more software applications an arbitrary number of times. Typically, files are organized in a file system which can be used on numerous different types of storage device exploiting different kinds of media which keeps track of where the files are located on the storage device(s) and enables user access. The format of a file is typically defined by its content since a file is solely a container for data, although, on some platforms the format is usually indicated by its filename extension, specifying the rules for how the bytes must be organized and interpreted meaningfully.

A “wireless interface” as used herein may refer to, but is not limited to, an interface for a PED, FED, or Wearable Device which exploits electromagnetic signals transmitted through the air. Typically, a wireless interface may exploit microwave signals and/or RF signals, but it may also exploit visible optical signals, infrared optical signals, acoustic signals, optical signals, ultrasound signals, hypersound signals, etc.

A “wired interface” as used herein may refer to, but is not limited to, an interface for a PED, FED, or Wearable Device which exploits electrical signals transmitted through an electrical cable or cables. Typically, a wired interface involves a plug or socket on the electronic device which interfaces to a matching socket or plug on the electrical cable(s). An electrical cable may include, but not be limited, coaxial cable, an electrical mains cable, an electrical cable for serial communications, an electrical cable for parallel communications comprising multiple signal lines, etc.

A “geofence” as used herein may refer to, but is not limited to, a virtual perimeter for a real-world geographic area which can be statically defined or dynamically generated such as in a zone around a PED's location. A geofence may be a predefined set of boundaries which align with a real world boundary, e.g. state line, country etc., or generated boundary such as a school zone, neighborhood, etc. A geofence may be defined also by an electronic device's ability to access one or more other electronic devices, e.g. beacons, wireless antennas etc.

A “mind map” as used herein refers to, but is not limited to, a diagram used to visually organize information. A mind map is hierarchical and shows relationships amongst the elements of the whole. A mind map may relate to a single concept or multiple concepts. Typically, a mind map comprises an object, e.g. an image in the center of a blank page, to which are subsequently associated representations of ideas such as images, words, parts of words etc. Major ideas are connected directly to the central concept, and other ideas branch out from those major ideas. With electronically generated mind maps within a software application the representation of associated ideas can be extended to any form of electronic content.

An “idea” as used herein refers to, but is not limited to, an item within a mind map. Accordingly, an idea may be represented by text, an image, or other electronic content and is one block within a hierarchy of ideas associated with a topic, project, etc. which is the subject of the mind map.

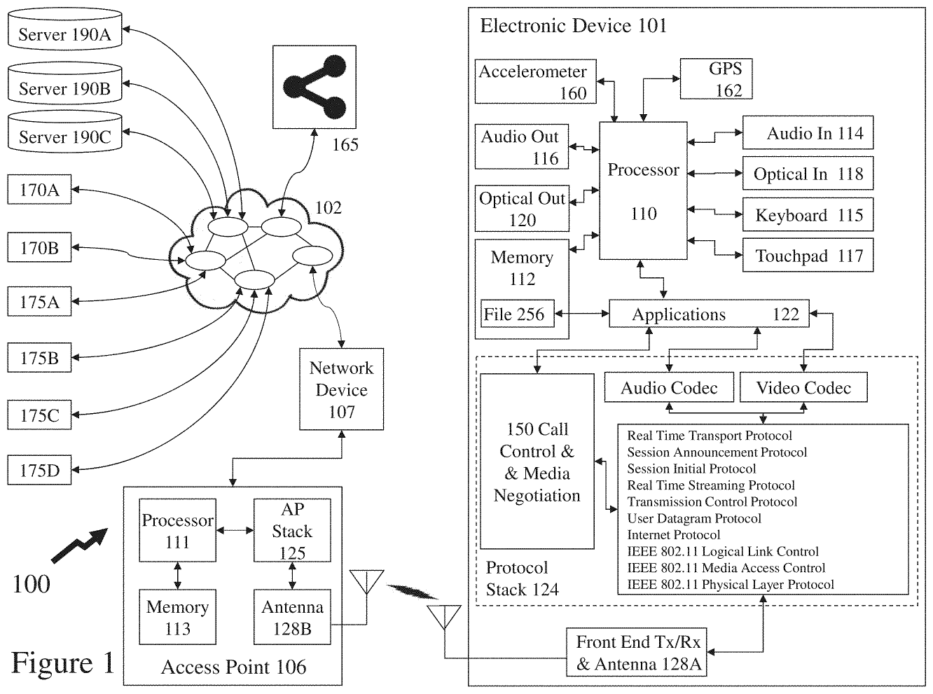

Now referring to FIG. 1 there is depicted a schematic 100 of a network to which an Electronic Device 101 supporting Remote Access System (RAS) Systems, Applications and Platforms (SAPs) and RAS-SAP features according to embodiments of the invention is connected. Electronic Device 101 may, for example, be a PED, a FED, or a wearable device and may include additional elements above and beyond those described and depicted. Also depicted in conjunction with the Electronic Device 101 are exemplary internal and/or external elements forming part of a simplified functional diagram of an Electronic Device 101 within an overall simplified schematic of a system supporting SAP features according to embodiments of the invention which include includes an Access Point (AP) 106, such as a Wi-Fi AP for example, a Network Device 107, such as a communication server, streaming media server, and a router. The Network Device 107 may be coupled to the AP 106 via any combination of networks, wired, wireless and/or optical communication links. Also connected to the Network 102 are Social Media Networks (SOCNETS) 165; first and second remote systems 170A and 170B respectively; first and second websites 175A and 175B respectively; first and third 3rd party service providers 175C and 175E respectively; and first to third servers 190A to 190C respectively.

The Electronic device 101 includes one or more Processors 110 and a Memory 112 coupled to Processor(s) 110. AP 106 also includes one or more Processors 111 and a Memory 113 coupled to Processor(s) 210. A non-exhaustive list of examples for any of Processors 110 and 111 includes a central processing unit (CPU), a digital signal processor (DSP), a reduced instruction set computer (RISC), a complex instruction set computer (CISC), a graphics processing unit (GPU) and the like. Furthermore, any of Processors 110 and 111 may be part of application specific integrated circuits (ASICs) or may be a part of application specific standard products (ASSPs). A non-exhaustive list of examples for Memories 112 and 113 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

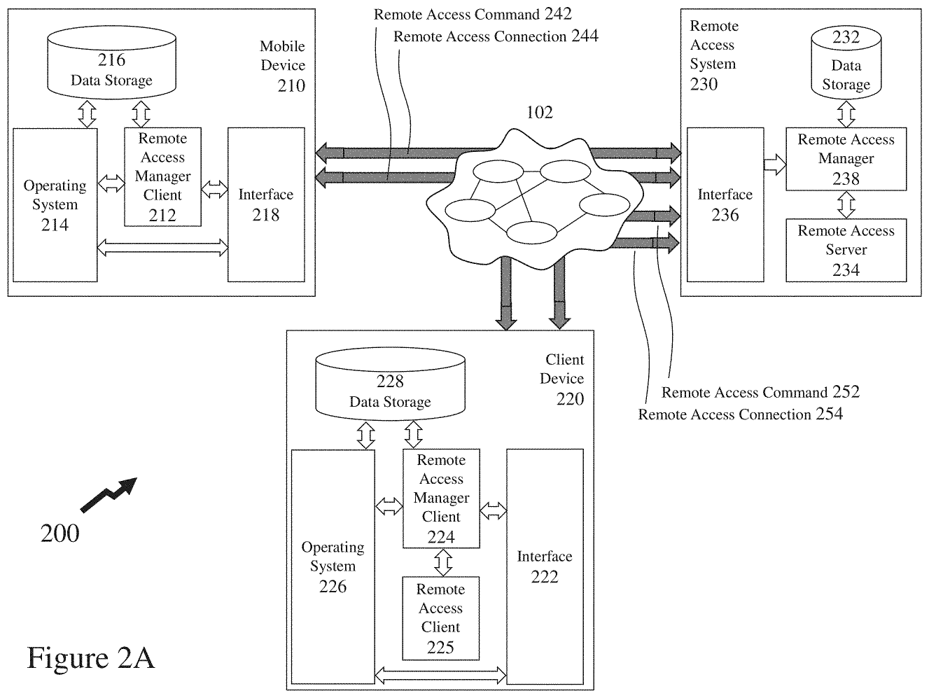

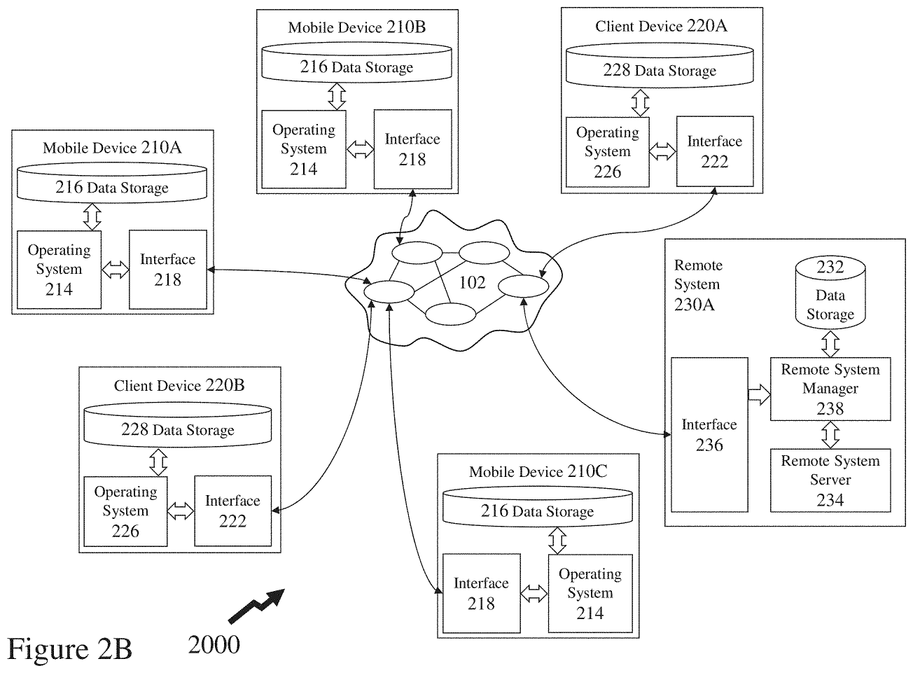

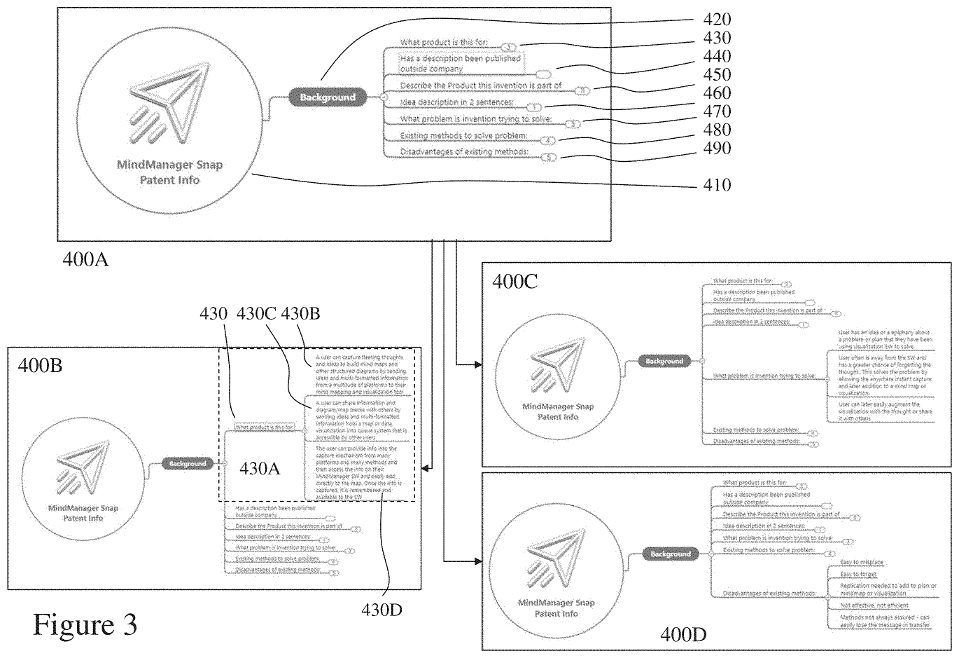

Electronic Device 101 may include an audio input element 214, for example a microphone, and an Audio Output Element 116, for example, a speaker, coupled to any of Processor(s) 110. Electronic Device 101 may include an Optical Input Element 218, for example, a video camera or camera, and an Optical Output Element 220, for example an LCD display, coupled to any of Processor(s) 110. Electronic Device 101 also includes a Keyboard 115 and Touchpad 117 which may for example be a physical keyboard and touchpad allowing the user to enter content or select functions within one of more Applications 122. Alternatively, the Keyboard 115 and Touchpad 117 may be predetermined regions of a touch sensitive element forming part of the display within the Electronic Device 101. The one or more Applications 122 that are typically stored in Memory 112 and are executable by any combination of Processor(s) 110. Electronic Device 101 also includes Accelerometer 160 providing three-dimensional motion input to the Processor(s) 110 and GPS 162 which provides geographical location information to Processor(s) 110. as described and depicted below in respect of FIGS. 2 and 3 respectively an Application 122 may support communications with a remote access system allowing one or more remote sessions to be established each associated with one or more Virtual Machines (VMs) allowing non-native applications (e.g. those requiring an Operating System (OS) different to that in execution upon the Processor 110) to be accessed and executed.

Electronic Device 101 includes a Protocol Stack 124 and AP 106 includes an AP Stack 125. Within Protocol Stack 124 is shown an IEEE 802.11 protocol stack but alternatively may exploit other protocol stacks such as an Internet Engineering Task Force (IETF) multimedia protocol stack for example or another protocol stack. Likewise, AP Stack 125 exploits a protocol stack but is not expanded for clarity. Elements of Protocol Stack 124 and AP Stack 125 may be implemented in any combination of software, firmware and/or hardware. Protocol Stack 124 includes a presentation layer Call Control and Media Negotiation module 150, one or more audio codecs and one or more video codecs. Applications 122 may be able to create maintain and/or terminate communication sessions with the Network Device 107 by way of AP 106 and therein via the Network 102 to one or more of Social Networks (SOCNETS) 165; first and second remote systems 170A and 170B respectively; first and second websites 175A and 175B respectively; first and third 3rd party service providers 175C and 175E respectively; and first to third servers 190A to 190C respectively. As described below in respect of FIGS. 2 and 3 a Remote Access System may be executed by and/or accessed by the Electronic Device 101 via the Network 102 on one or more of first and second websites 175A and 175B respectively; first and third 3rd party service providers 175C and 175E respectively; and first to third servers 190A to 190C respectively.

Typically, Applications 122 may activate the Call Control & Media Negotiation 150 module or other modules within the Protocol Stack 124 It would be apparent to one skilled in the art that elements of the Electronic Device 101 may also be implemented within the AP 106 including but not limited to one or more elements of the Protocol Stack 124 Portable electronic devices (PEDs) and fixed electronic devices (FEDs) represented by Electronic Device 101 may include one or more additional wireless or wired interfaces in addition to or in replacement of the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1010, DSL, Dial-Up, DOCSIS, Ethernet, G.hn, ISDN, MoCA, PON, and Power line communication (PLC).

The Front End Tx/Rx & Antenna 128A wirelessly connects the Electronic Device 101 with the Antenna 128B on Access Point 206, wherein the Electronic Device 101 may support, for example, a national wireless standard such as GSM together with one or more local and/or personal area wireless protocols such as IEEE 802.11 a/b/g Wi-Fi, IEEE 802.16 WiMAX, and IEEE 802.15 Bluetooth for example. Accordingly, it would be evident to one skilled the art that the Electronic Device 101 may accordingly download original software and/or revisions for a variety of functions. In some embodiments of the invention the functions may not be implemented within the original as sold Electronic Device 101 and are only activated through a software/firmware revision and/or upgrade either discretely or in combination with a subscription or subscription upgrade for example. Accordingly, as will become evident in respect of the description below the Electronic Device 101 may provide a user with access to one or more RAS-SAPs including, but not limited to, software installed upon the Electronic Device 101 or software installed upon one or more remote systems such as those associated with Social Networks (SOCNETS) 165; first to fifth remote systems 170A to 170E respectively; first and second websites 175A and 175B respectively; and first to third 3rd party service provides 175C to 175E respectively; and first to third servers 190A to 190C respectively for example.

Accordingly, within the following description a remote system/server may form part or all of the Social Networks (SOCNETS) 165; first and second remote systems 170A and 170B respectively; first and second websites 175A and 175B respectively; first and third 3rd party service providers 175C and 175E respectively; and first to third servers 190A to 190C respectively. Within the following description a local client device may be Electronic Device 101 such as a PED, FED or Wearable Device and may be associated with one or more of the Social Networks (SOCNETS) 165; first and second remote systems 170A and 170B respectively; first and second websites 175A and 175B respectively; first and third 3rd party service providers 175C and 175E respectively; and first to third servers 190A to 190C respectively. Similarly, a storage system/server within the following descriptions may form part of or be associated within Social Networks (SOCNETS) 165; first and second remote systems 170A and 170B respectively; first and second websites 175A and 175B respectively; first and third 3rd party service providers 175C and 175E respectively; and first to third servers 190A to 190C respectively.

Now referring to FIG. 2A there is depicted a schematic diagram 200 depicting an exemplary configuration for accessing a mind managing software application, a standalone content acquisition software application which acquires and provides content to a mind mapping software application or a browser plug-in accessed to acquire content for a mind mapping software application wherein these are accessed via a remote access session connecting a Mobile Device 210 and/or a Client Device 220 to a Remote Access System 230. As depicted the Mobile Device 210 is in communication with the Remote Access System 230 over a Network 102, such as a local area network (LAN), wide area network (WAN), or the Internet. Further, the Client Device 220 is in communication with the Remote Access System 230 over the Network 102. Optionally, the remote sessions of the Mobile Device 210 and the Client Device 220 are independent sessions. The Mobile Device 210 and Client Device 220 may be associated with a common user or with different users. Optionally, the Remote Access System 230 may also host and/or initiate a remote access session at a predetermined time.

The Remote Access System 230 may include one or more computing devices that perform the operations of the Remote Access System 230 and may, for example be a server such as first to third Servers 190A to 190C respectively individually or in combination. It would be evident that the Mobile Device 210 may be a PED, FED, or Wearable Device. Accordingly, with a session involving only the Mobile Device 210 and the Remote Access System 230 the session is established, maintained and terminated in dependence upon one or more Remote Access Commands 242 over a Remote Access Connection 244 between the Mobile Device 210 and the Remote Access System 230. Accordingly, with a session involving only the Client Device 220 and the Remote Access System 230 the session is established, maintained and terminated in dependence upon one or more Remote Access Commands 224 over a Remote Access Connection 254 between the Client Device 220 and the Remote Access System 230. When the session involves both the Mobile Device 210 and the Client Device 220 with the Remote Access Server then the session is established, maintained and terminated in dependence upon one or more Remote Access Commands 242 over a Remote Access Connection 244 between the Mobile Device 210 and the Remote Access System 230 and one or more Remote Access Commands 224 over a Remote Access Connection 254 between the Client Device 220 and the Remote Access System 230.

A remote access session may for example be an instance of a virtual machine which is an instance of a user session or profile in execution upon the Remote Access System 230 which is accessed remotely at the Mobile Device 210 and/or Client Device 220 by a client application in execution upon the respective Mobile Device 210 and/or Client Device 220. The Mobile Device 210 and/or Client Device 220 connects to the Remote Access System 230 and initiates either a new remote access session or accesses an established remote access session either in execution or suspended pending user re-initiation. Once the Remote Access System 230 causes the Mobile Device 210 and/or Client Device 220 to connect to the remote access session, a user of the Mobile Device 210 and/or Client Device 220 may then use the remote access session to access the resources and/or applications of the server. Within the following embodiments of the invention the remote access session may be related to the execution of a mind mapping software application, execution of a content acquisition software application which is executed independent of a mind mapping software application to acquire content which is provided to a queue of a mind mapping software application, or a browser plug-in with a browser accessed in a remote session to acquire content which is provided to a queue of a mind mapping software application. For example, a user employing an Apple™ Watch employing the Apple™ iOS operating system may access a Google™ Chrome browser within a remote session and therein access a browser plug-in, e.g. Corel™ MindManager™ Chrome extension to acquire content which is then accessible as outlined below within a mind manager software tool.

A remote access session may be possible only within a predetermined geofence, e.g. a Mobile Device 210 associated with user of an enterprise can only successfully establish a remote access session if the Mobile Device 210 is within one or more geofences where each geofence is associated with a location of the enterprise and/or a residence of the user, for example. Similarly, Client Device 220 may be similarly geofenced such that movement of the Client Device 220 inside a geofence allows a remote access session to be established and movement of the Client Device 220 outside of the geofence prevents a remote session being established and/or terminates an existing remote session. The application(s) accessible to the user within a remote access session are determined by whether the Mobile Device 210 and/or Client Device 220 used by the user is within a geofence. A user may define the geofences themselves, e.g. their residence or set it to some default inaccessible geofence (e.g. one of zero radius or the North Pole for example) such that upon loss of the Mobile Device 210 and/or Client Device 220 access to application(s) and/or remote access sessions is prevented. The Mobile Device 210 and/or Client Device 220 may determine their location by one or more means including, but not limited to, accessing a global positioning system (GPS, such as GPS receiver 162 as depicted in FIG. 1), by triangulation with or proximity to signals from one or more antennas with known locations, such as cellular data network towers in a cellular data network or Wi-Fi devices in the Wi-Fi networks. Optionally, the Mobile Device 210 and/or Client Device 220 may establish its location by communicating with another device in its proximity, e.g. a Mobile Device 210 without a GPS may establish a personal area network connection to another device, e.g. a smartphone of the user, and therein obtain its location.

Within embodiments of the invention multiple geofences may be established with respect to acquiring content for and employing content within a mind mapping software application. For example, the mind mapping software application may be geofenced with a first geofence whilst execution of a content acquisition software application which is executed independent of a mind mapping software application to acquire content which is provided to a queue of the mind mapping software application is geofenced with a second geofence whilst a browser plug-in accessed in a remote session to acquire content which is provided to a queue of a mind mapping software application may be associated with a third geofence. Accordingly, the first geofence may be associated with the user's place of work, the second geofence is global but locked to a specific PED of the user and the third geofence is global without any device limitation. Within other embodiments of the invention each geofence may include a time dependent component such that the geofence is defined according to a schedule. It would be evident that the embodiments of the invention below may be geofenced either with static geofences, temporally defined geofences or geofences defined upon one or more factors associated with the user such as user biometric(s) for example.

Now referring to FIG. 2B there is depicted a schematic diagram 2000 depicting an exemplary configuration for accessing a mind managing software application, a standalone content acquisition software application which acquires and provides content to a mind mapping software application or a browser plug-in accessed to acquire content for a mind mapping software application wherein these are accessed via first to third Mobile Devices 210A to 210C respectively and/or first and second Client Devices 220A and 220B to a Remote System 230A. As depicted each of the first to third Mobile Devices 210A to 210C respectively is in communication with the Remote System 230A over a Network 102, such as a local area network (LAN), wide area network (WAN), or the Internet. Further, each of the first and second Client Devices 220A and 220B is in communication with the Remote System 230A over the Network 102.

Each of the first to third Mobile Devices 210A to 210C respectively as depicted comprises an Interface 218, Operating System 214 and Data Storage 216 having similar functions and structure as those described above with respect to the same elements in FIG. 2A. Each of the first and second Client Devices 220A and 220B as depicted comprises an Interface 222, Operating System 226 and Data Storage 228 having similar functions and structure as those described above with respect to the same elements in FIG. 2A. Similarly, Remote System 230 is depicted as comprising an Interface 236, Remote System Server 234 and Data Storage 232 having similar functions and structure as those described above with respect to the same elements in FIG. 2A. The Remote System 230 also comprises a Remote System Manager 230A which manages the overall functionality of the Remote System 230A.

The Remote System 230A may include one or more computing devices that perform the operations of the Remote System 230A and may, for example be a server such as first to third Servers 190A to 190C respectively individually or in combination. It would be evident that each of the first to third Mobile Devices 210A to 210C respectively may be a PED, FED, or Wearable Device. Accordingly, a user upon one of first to third Mobile Devices 210A to 210C respectively may acquire electronic content for subsequent use within a mind map and/or display within a mind mapping application with a standalone content acquisition software application which acquires and provides content to a mind mapping software application or a browser plug-in accessed to acquire content for a mind mapping software application wherein the electronic content acquired is transmitted and stored upon the Remote System 230A via the Network 102. In a similar manner users upon first to third Mobile Devices 210A to 210C respectively may access electronic content stored upon the Remote System 230A within a mind mapping application and insert, keep, archive, delete the electronic content within the mind mapping application with respect to one or more mind maps. As will be discussed below such multiple user acquisition of electronic content for mind maps allows multiple contributors associated with a single user to provide that user with electronic content which is then employed by the user within a mind map or mind maps. Further, as will be discussed below, multiple user acquisition of electronic content for mind maps allows multiple contributors associated with a team or group provide that team or group with electronic content which is then employed by one or more users within the team or group within a mind map or mind maps.

The acquisition of content and/or its use by users associated with one or more of the first to third Mobile Devices 210A to 210C respectively and/or first and second Client Devices 220A and 220B respectively may be possible only within a predetermined geofence, e.g. first Mobile Device 210A for example is associated with user of an enterprise can only successfully either acquire and/or provide electronic content to the Remote System 230 when the first Mobile Device 210A is within one or more geofences where each geofence is associated with a location of the enterprise and/or a residence of the user, for example. Similarly, first Client Device 220A for example, may be similarly geofenced such that movement of the first Client Device 220A inside a geofence allows access to the Remote System 230A to be established and movement of the first Client Device 220A outside of the geofence prevents their communications with the Remote System 230A. Optionally, the application(s) accessible to the user to either acquire/provide electronic content and/or receive/employ electronic content are determined by whether the first to third Mobile Devices 210A to 210C respectively and/or first and second Client Devices 220A and 220B respectively used by the user is within a geofence. A user may define the geofences themselves, e.g. their residence or set it to some default inaccessible geofence (e.g. one of zero radius or the North Pole for example) such that upon loss of the first to third Mobile Devices 210A to 210C respectively and/or first and second Client Devices 220A and 220B respectively associated with them access to application(s) and/or remote system is prevented. The first to third Mobile Devices 210A to 210C respectively and/or first and second Client Devices 220A and 220B respectively may determine their location by one or more means including, but not limited to, accessing a global positioning system (GPS, such as GPS receiver 162 as depicted in FIG. 1), by triangulation with or proximity to signals from one or more antennas with known locations, such as cellular data network towers in a cellular data network or Wi-Fi devices in the Wi-Fi networks. Optionally, the first to third Mobile Devices 210A to 210C respectively and/or first and second Client Devices 220A and 220B respectively may establish their locations by communicating with another device in its proximity, e.g. first Mobile Device 210A without a GPS may establish a personal area network connection to another device, e.g. a smartphone of the user, and therein obtain its location.

Within embodiments of the invention multiple geofences may be established with respect to acquiring content for and employing content within a mind mapping software application. For example, the mind mapping software application may be geofenced with a first geofence whilst execution of a content acquisition software application which is executed independent of a mind mapping software application to acquire content which is provided to a queue of the mind mapping software application is geofenced with a second geofence whilst a browser plug-in accessed in a remote session to acquire content which is provided to a queue of a mind mapping software application may be associated with a third geofence. Accordingly, the first geofence may be associated with the user's place of work, the second geofence is global but locked to a specific PED of the user and the third geofence is global without any device limitation. Within other embodiments of the invention each geofence may include a time dependent component such that the geofence is defined according to a schedule. It would be evident that the embodiments of the invention below may be geofenced either with static geofences, temporally defined geofences or geofences defined upon one or more factors associated with the user such as user biometric(s) for example.

Within embodiments of the invention multiple time restrictions (referred to hereinafter as time-fences) rather than geofences may be established with respect to acquiring content for and employing content within a mind mapping software application etc. For example, the mind mapping software application may be time-fenced with a first time-fence whilst execution of a content acquisition software application which is executed independent of a mind mapping software application to acquire content which is provided to a queue of the mind mapping software application is time-fenced with a second time-fence whilst a browser plug-in accessed in a remote session to acquire content which is provided to a queue of a mind mapping software application may be associated with a third time-fence. Accordingly, for example, the first time-fence associated with respect to employing the acquired content may be each weekday 7 am-6 pm; the second time-fence associated with the mind mapping software application may be weekday 7 am-6 am and Saturday 9 am-5 pm; and the third time-fence associated with the browser plug-in may be any day anytime. In this manner, an enterprise may establish time-fences to enforce workweek time limits for example within a particular regulatory regime. Optionally, a time-fence may be a time limit within a predetermined time frame, e.g. 35 hours within a 7 day period (1 week).

Within the following description with respect to FIGS. 3 to 10 respectively the acquisition of electronic content for inclusion within and/or the insertion of electronic content within a mind mapping software application is described according to embodiments of the invention. The electronic content may be acquired, for example, through a software application in execution upon the user's device, e.g. Mobile Device 210 and/or Client Device 220 in FIG. 2A/2B, or in execution upon a remote system, e.g. Remote Access System 230/Remote System 2A in FIGS. 2A/2B respectively. For example, the acquisition of electronic content may be from an installed software application upon the user's Client Device 220, e.g. an installed instance of Google™ Chrome, or to an instance of the software application upon a remote system, e.g. Remote Access System 230, accessed by the user through a remote session with a VM, e.g. an instance of Apple™ Safari running on a remote server associated with the user such as an organization or a third party service provider for example. The VM being accessed from the user's PED, e.g. Mobile Device 210, or FED, e.g. Client Device 220. The VM and remote access system, for example, being managed through a software application such as Parallels™ Remote Application Server, for example, and accessed through an instance of an application upon the user's device, e.g. Parallels™ Desktop.

Alternatively, the user may be accessing from a mobile device to their client device or remote system with software such as Parallels™ Access for example. However, it would be evident that any specific software application identified is an example and does not limit the actual software application employed to provide or support embodiments of the invention.

Alternatively, the user may be accessing, for example from a mobile device, such as first to third Mobile Clients 210A to 210C respectively and/or a client device, e.g. first and second Client Devices 220A and 220B respectively, to a remote system, e.g. Remote System 230A.

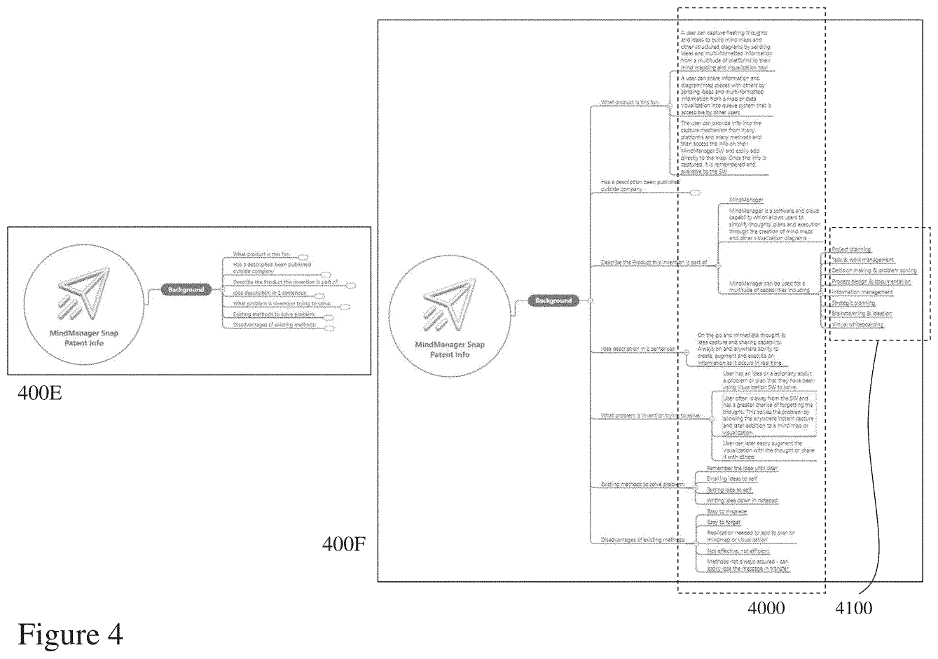

Within the following description with respect to FIGS. 4 to 10 respectively the acquisition of electronic content for inclusion within and/or the insertion of electronic content within a mind mapping software application is described with respect to adding an “idea.” As noted above, an idea, refers to a block within a hierarchy associated with the subject of the mind map.

Similarly, the insertion of the acquired electronic content may be, for example, through a software application in execution upon the user's device, e.g. Mobile Device 210 and/or Client Device 220 in FIG. 2A/2B, or in execution upon a remote system, e.g. Remote Access System 230/Remote System 2A in FIGS. 2A/2B respectively. For example, the insertion of acquired content may be to an installed software application upon the user's Client Device 220, e.g. an installed instance of MindManager, or to an instance of the software application upon a remote system, e.g. Remote Access System 230, accessed by the user through a remote session with a VM, e.g. an instance of MindManager™ running on a remote server associated with the user such as an organization or a third party service provider for example. The VM being accessed from the user's PED, e.g. Mobile Device 210, or FED, e.g. Client Device 220. The VM and remote access system, for example, being managed through a software application such as Parallels™ Remote Application Server, for example, and accessed through an instance of an application upon the user's device, e.g. Parallels™ Desktop.

Alternatively, the user may be accessing from a mobile device to their client device or remote system with software such as Parallels™ Access for example. However, it would be evident that any specific software application identified is an example and does not limit the actual software application employed to provide or support embodiments of the invention.

Alternatively, the user may be accessing, for example from a mobile device, such as first to third Mobile Clients 210A to 210C respectively and/or a client device, e.g. first and second Client Devices 220A and 220B respectively, to a remote system, e.g. Remote System 230A.

FIGS. 3 and 4 depict exemplary mind maps as provided by a mind mapping software application according to the prior art. The exemplary mind map being with respect to the methods and systems according to embodiments of the invention. Accordingly, as depicted in first mind map (MM) 400A comprises a Central Idea 410, “MindManager Snap Patent Info” to which a hierarchy of associations are attached. In first MM 400A this being a First Level Idea 420 “Background” and first to seventh Second Level Ideas 430 to 490 respectively. Additional First Level Ideas 420 may be associated with the Central Idea 410 to which other Second Level Ideas may be associated. The number of levels of hierarchy supported within a mind map may be defined, for example, by the user, by the mind mapping software (MMSW), or a template employed within the MMSW. First MM 400A being rendered to a user within a MMSW either in execution upon a device associated with the user directly or through a remote session/virtual machine (RS/VM).

Within first MM 400A the first to seventh Second Level Ideas 430 to 490 respectively comprise:
First Second Level Idea 430 being “What product is this for:” being depicted as a branch from First Level Idea 410 which ends with an icon comprising the number 3, this being, as will be evident from second to fourth MM 400B to 400D respectively, the number of elements within a third level of the hierarchy;
Second Second Level Idea 440 being “Has a description been published outside the company”;
Third Second Level Idea 450 being “Describe the Product the invention is part of”;
Fourth Second Level Idea 460 being “Idea Description in 2 sentence”;
Fifth Second Level Idea 470 being “What problem is the invention trying to solve”;
Sixth Second Level Idea 480 being “Existing methods to solve problem”; and
Seventh Second Level Idea 490 being “Disadvantages of existing methods.”

Each of the second to seventh Second Level Ideas 440 to 490 having icons identifying that there are 0, 3, 1, 3, 4, and 5 elements within a third level of the hierarchy associated with each respective second level of the hierarchy. If the user selects the icon associated with a particular Second Level Idea then the GUI re-renders the visual map with the next level of the hierarchy expanded. Accordingly, in second to fourth MMs 400B to 400D respectively the user has expanded First Second Level Idea 430, Fifth Second Level Idea 470 and Seventh Second Level Idea 490 respectively. Within second MM 400B the identified region 430A contains the Second Second Level Idea 430 and its associated first to third Third Level Ideas 430B to 430D respectively.

The user may have, within embodiments of the invention, generated their mind map from a mind map template, such as that depicted in fifth MM 400E in FIG. 4 which contains the Central Idea 410 with the First Level Idea 420 and first to seventh Second Level Ideas 430 to 490 respectively.

The user may expand and contract the hierarchy of each idea discretely from the others or expand them all as depicted in sixth MM 400F in FIG. 4. As depicted, therefore, there are 19 items in the Second Level Ideas 4000 and 8 items in a Third Level Ideas 4100. As depicted the ideas within Third Level Ideas 4100 are associated with a single item in the Second Level Ideas 4000 although it would be evident that each idea in the Second Level Ideas 4000 may have Third Level Ideas associated with it. Further, the hierarchy may extend to other levels.

Within the MMSW generating the mind map depicted in FIGS. 3 and 4 a generates each entry, e.g. into a Second Level Idea of Second Level Ideas 4000 in FIG. 4 or Third Level Idea of Third Level Ideas 4100 in FIG. 4, for example, by selecting an item in the higher level of the hierarchy, e.g. First Second Level Idea 430, selects within a pop-up or drop-down menu to add an item, first Third Level Idea 430B, and enters the associated text for that item. By repeating this process the user can add ideas to an initial Central Idea 410 (which they may have also created) or to a template thereby generating the mind map. Further, within the prior art the user must load the mind map in order to add an item to it.

Accordingly, within the prior art if a user has an idea that they have been searching for or remembers something that they need to add to a mind map they must either access the mind map software and add it then or make a note of it within another application or upon a piece of paper etc. and hope they do not lose the paper or forget the note within the other application. Irrespective of which manner the new idea must open the mind map, select the idea they want to add the new idea to and then add it to the mind map. If the user identifies an item of electronic content which is relevant then the situation is usually worse as they must “write” down the uniform resource location (URL) or web address for the item of content and type this in.

Accordingly, the inventors have established an alternate methodology allowing a user or others associated with the user to capture an idea, i.e. grab their thoughts, data points, pieces of content etc., at the point in time they occur, transfer these to the mind manager system, and subsequently retrieve these for rendering to the user allowing the user to then add them to the mind map or appropriate mind maps if the captured ideas relate to multiple different mind maps.

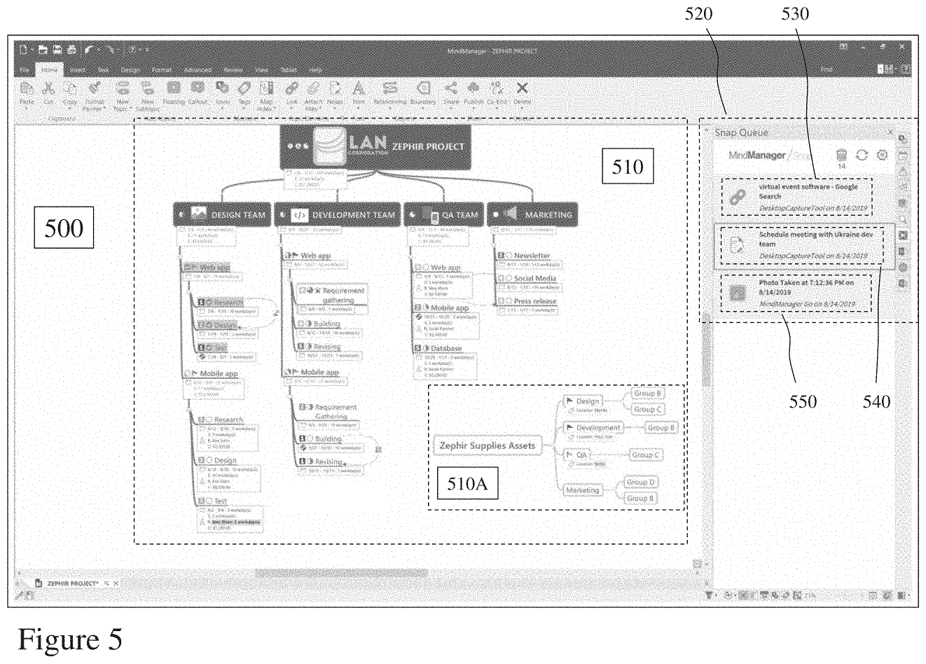

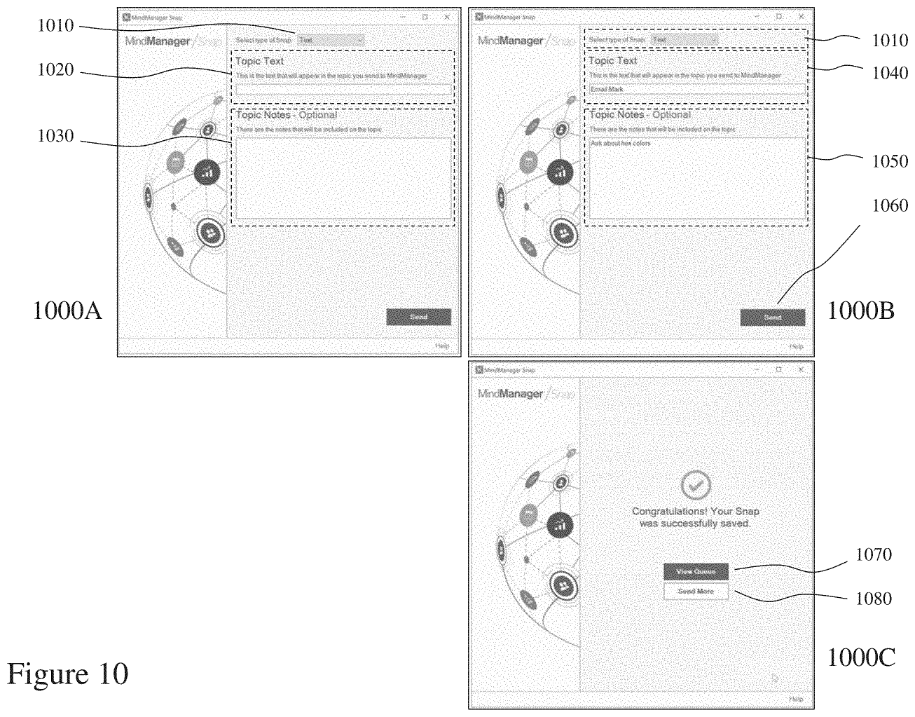

Accordingly, referring to FIGS. 5 to 8 there are depict exemplary first to fourth mind manager software (MMSW) graphical user interfaces (GUIs) 500 to 800 respectively depicting the insertion of electronic content from a queue into a visual mind map rendered to a user through a mind mapping software application according to an embodiment of the invention whilst FIG. 10 depicts exemplary first to third Snap Tool GUIs 1000A to 1000C respectively for the acquisition of electronic content within a web browser according to an embodiment of the invention by a software application, referred to by the inventors as “snapping” an idea. Accordingly, for reference the external independent idea acquisition software application is referred to as Snap or a Snap Tool.

It would be evident that the insertion of electronic content from a queue into a visual mind map rendered to a user through a mind mapping software application according to an embodiment of the invention according to embodiments of the invention described with respect to FIGS. 5 to 8 and the acquisition of electronic content within a web browser according to an embodiment of the invention by a software application according to embodiments of the invention described with respect to FIG. 10 may be performed upon Mobile Device 210 and/or Client Device 220 with respect to a Remote Access System 230 as described and depicted in FIG. 2A or with first to third Mobile Devices 210A to 210C and/or first and second Client Devices 220A and 220B with respect to a Remote System 230 as described and depicted in FIG. 2B.

Referring initially to first MMSW 500 there is depicted a GUI for the MMSW wherein the user has loaded a mind map (MM) 510, entitled Zephir Project, which comprises a hierarchy of ideas associated with teams of the Zephir Project being run by LAN Corporation. Also depicted is subsidiary MM 510A associated with the MM 510, which in this instance depicts the assets provided by Zephir to the different teams. Accordingly, this portion of the MMSW 500 depicted by MM 510 is similar to that within the prior art. However, at the right hand side there is also rendered to the user a Snap Queue 520 representing items acquired by the user using “Snap” the external independent idea acquisition software application according to embodiments of the invention such as described and depicted with respect to FIG. 10.

Within the Snap Queue 520 are first to third Snaps 530 to 550; these being:
First Snap 530 entitled “Virtual event software—Google Search' which represents a result of a Google search performed within a browser using a search engine, Google, where the search is pasted into the Snap Tool (e.g. https://www.google.com/search?q=mulan&oq=mulan&aqs=chrome..69i57j46j0j46j 0j46j012.1518j0j9&sourceid=chrome&ie=UTF-8 for “Mulan”);
Second Snap 540 entitled “Schedule meeting with Ukraine dev team” which is simply a text entry, e.g. a note, comment, thought, concept etc.; and
Third Snap 550 entitled “Photo Taken at 7:12:36 PM on Aug. 14, 2019” which represents an image captured by the Snap Tool via a camera of an electronic device the Snap Tool was in execution upon, e.g. the user's smartphone.

Further, each of the first to third Snaps 530 to 550 includes a source of the content, e.g. “DesktopCaptureTool”, and a date the snap was acquired, e.g. Aug. 14, 2019. Accordingly, the first to third Snaps 530 to 550 were acquired by the user externally to the MMSW itself with a Snap Tool. Accordingly, subsequent to the generation of the first to third Snaps 530 to 550 the user has accessed the MMSW, wherein the Queue 520 was rendered to them, and has then uploaded the project “Zephir Project” which leads to MM 510 being rendered.

Within the following description the first to third Snaps 530 to 550 are described and depicted with respect to a common mind map, e.g. MM 510. However, it would be evident to one of skill in the art that the first to third Snaps 530 to 550 may relate to different mind maps and accordingly the user can subsequently load up each mind map, have it rendered, and then add the appropriate Snap to the mind map.

Optionally, within another embodiment of the invention the Snap Tool employed to generate each of the first to third Snaps 530 to 550 may include an option to associate the snap with a mind map. Accordingly, in this instance the MMSW when opened would not show any items within the Queue 520 but would render the first to third Snaps 530 to 550 respectively upon the user opening the MM 510 to which they had been associated.

As will become evident subsequently the Snap Tool may also provide filters to assign the snap to a mind map, e.g. based upon mind map title, projects to which the user generating the “snap” is identified as a contributor, or to specific user without a project in which instance the snap may be rendered to the user within the Queue 520 upon their loading of the MMSW prior to even loading the MM 510.

Optionally, within another embodiment of the invention the MMSW provides one or more filters to filter the snaps based upon user selections within the MMSW rather than automatically filtering based upon rendering only those snaps associated with a mind map loaded by the user.

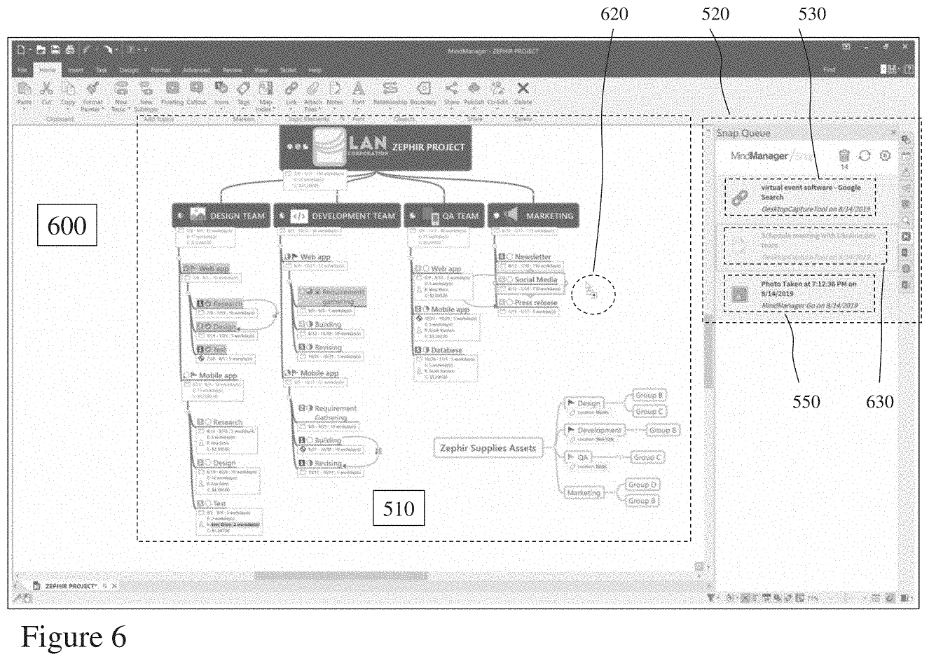

Now referring to MMSW 600 in FIG. 6 there is depicted a GUI for the MMSW wherein the user has selected a snap and is moving it, e.g. by a “select-drag-drop” process known to those of skill in the art for selecting, moving, and placing objects within a GUI. The selected snap being indicated by the different rendering of the selected snap, Greyed Out Snap 630, which is the second Snap 540 depicted in FIG. 5, and the current state of movement by the Cursor 620 which as an icon associated with it, a plus sign, indicating the cursor is moving an item. This being rendered over the currently rendered mind map, MM 510.

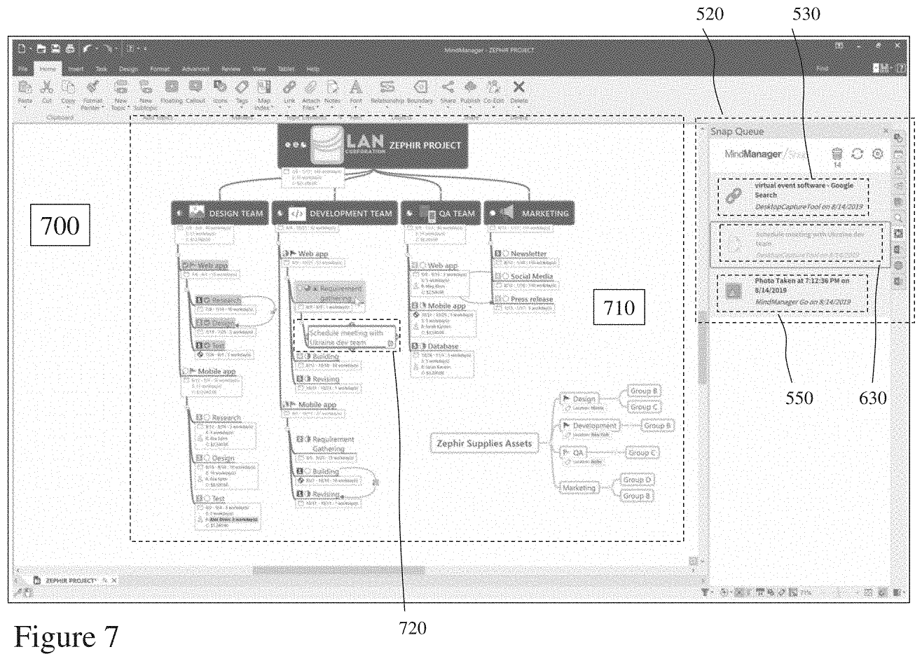

Subsequently, as depicted in MMSW 700 in FIG. 7 there is depicted a GUI for the MMSW wherein the user has moved the cursor within the mind map hierarchy and “dropped” the item wherein the MMSW renders the item as new Idea 720 within the modified MM 710. Accordingly, the user can now move the new Idea 720 within the modified 710 if the location is incorrect or whether they wish to raise (e.g. promote) or lower (e.g. demote) its level in the hierarchy, etc. They can also move it to other locations in the hierarchy associated with other ideas under the project etc. Such techniques being known by one of skill in the art.

Within embodiments of the invention the initial positioning of the “dropped” idea within the mind map may be determined based upon one or more rules established by the MMSW such as relating to proximity to an item in the MM, e.g. if dropped near an item the new idea should be below that item, if dropped on item the new idea should be added at that same level to the hierarchy, etc. The position of the “dropped” idea may also be determined in dependence upon a type of the idea being added, which is described further below in respect of first Snap Tool GUI 1000A in FIG. 10. For example, text may be added at any level of the hierarchy but images, URLs, etc. may only be added at specific levels.

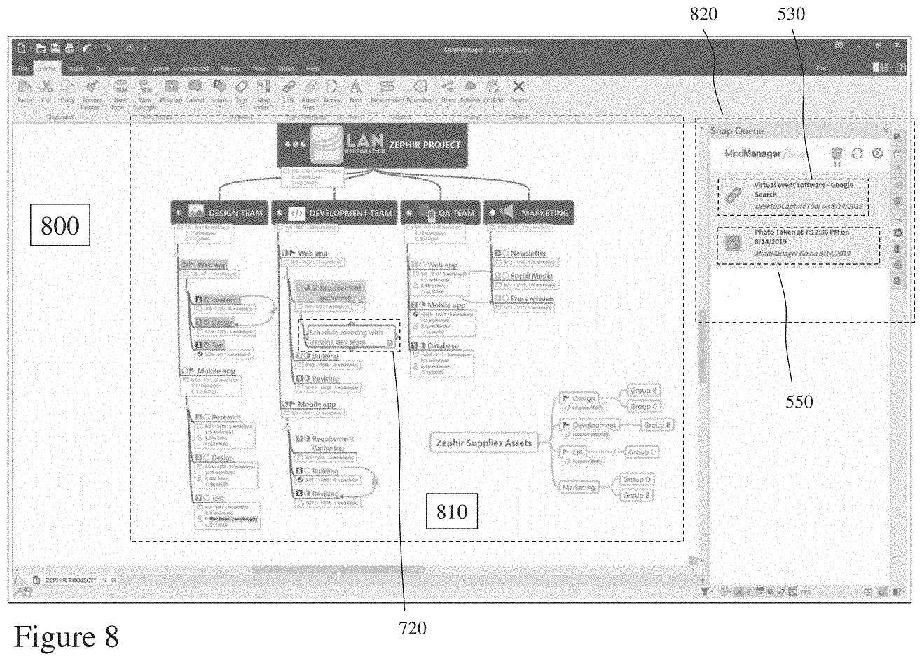

Accordingly, based upon the user accepting the location of new Idea 720 by one or more means as known to those of skill in the art the user is then presented with MMSW 800 in FIG. 8 wherein the new Idea 720 is displayed within the mind map, MM 810. This item has also been removed from the queue, which is depicted a Queue 820, now comprising first Idea 530 and third Idea 550. Accordingly, the user can repeat the process of adding the new ideas to the mind map or where the queue is not filtered by mind map, load another mind map and add a new idea from the queue to it.

It would therefore be evident that a user can add ideas to a mind map from a queue at a later date to that when the idea was acquired/realized. Further, as will become evident from the following description with respect to FIG. 10 the software for acquiring ideas, the Snap Tool, may be independent of the mind mapping software such that the ideas can be acquired/captured within different user activities upon different electronic devices, using software on different operating systems, using different remote sessions/virtual machines etc.

However, it would also be evident that the separation between acquisition of an idea and addition of the idea to a mind map or it is rendered to a user within a mind mapping software application could be “contemporaneous” such that, for example, scenarios including, but not limited to, those with respect to the scenario depicted in FIG. 2A with a Remote Access System 230, Local Device 210 and Client Device 220 may include, but are not limited to:
a user may be exploiting mind mapping software within a first remote session with a first software application upon a first virtual machine and capture the ideas within a second remote session with a second software application upon a second virtual machine from the same user electronic device, e.g. Client Device 220 in FIG. 2A;
a user may be exploiting mind mapping software within a first remote session with a first software application upon a first virtual machine upon a first electronic device, e.g. Mobile Device 210 in FIG. 2A, and capture the ideas within a second remote session with a second software application upon a second virtual machine upon a second electronic device, e.g. Client Device 220 in FIG. 2A;
a user may be exploiting mind mapping software within a remote session with a first software application upon a virtual machine and capture the ideas within a second software application in execution upon the same user electronic device as that used by the user for the remote session; and
a user may be exploiting mind mapping software within a software application in execution within a remote session upon a virtual machine, e.g. Mobile Device 210, and capture the ideas with a second software application upon another electronic device, e.g. Client Device 220 in FIG. 2A.

Further, the separation between acquisition of an idea and addition of the idea to a mind map or it is rendered to a user within a mind mapping software application could be “contemporaneous” or at different times with respect to the scenario depicted in FIG. 2B with a Remote System 230, first to third Local Devices 210A to 210C respectively and first and second Client Devices 220A-220B respectively. Accordingly, such scenarios may include, but are not limited to:
a user may be exploiting mind mapping software within a first software application upon a first electronic device and capture the ideas with a second software application upon the same electronic device, e.g. one of first to third Local Devices 210A to 210C respectively or first and second Client Devices 220A-220B respectively in FIG. 2B;
a user may be exploiting mind mapping software within a first software application upon a first electronic device, e.g. one of first to third Local Devices 210A to 210C respectively or first and second Client Devices 220A-220B respectively in FIG. 2B, and capture the ideas within a second software application upon a second electronic device, e.g. another of first to third Local Devices 210A to 210C respectively or first and second Client Devices 220A-220B respectively Client Device 220 in FIG. 2B.

Whilst within FIGS. 5 to 8 the items within the queue are added to an existing mind map it would be evident that the items within the queue may be employed to generate a new mind map from an initial blank template or added to a template selected by a user. For example, where the currently rendered mind map is a template initially loaded the items moved from the queue onto the template may be used to populate elements of the template.

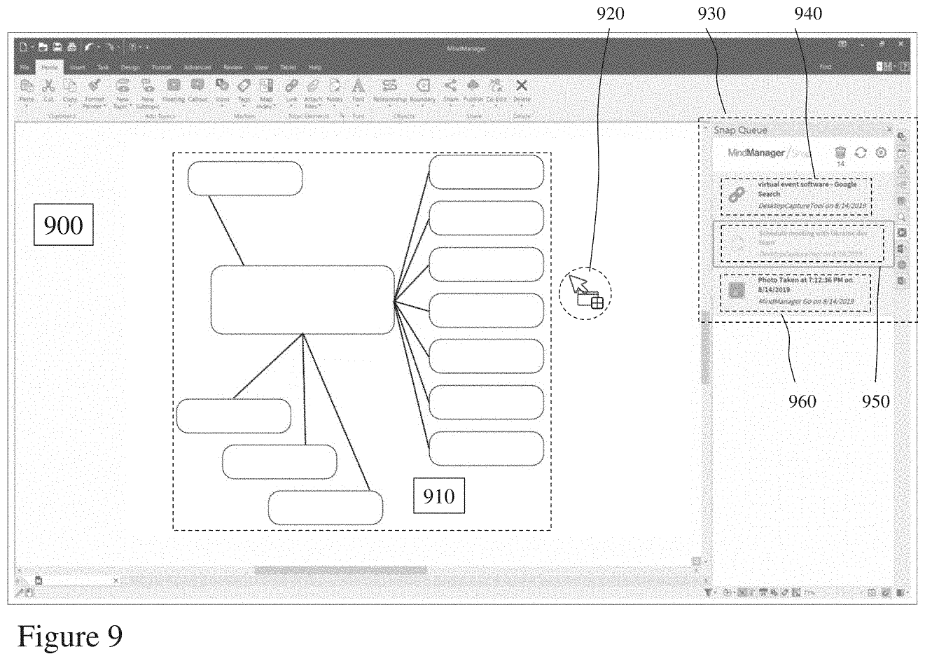

Referring to FIG. 9 there is depicted a GUI 900 for a MMSW wherein the user has loaded a mind map Template 910 and has selected an idea, second Idea 950, within the rendered Queue 930 of ideas, first to third Ideas 940 to 960 respectively, and is moving this onto the mind map Template 910 via Cursor 920. When “dropped” onto the mind map Template 910 the idea, e.g. second Idea 950, over one of the existing blank elements of the mind map Template 910 then the idea is inserted into that element. If the user “drops” the idea near one of the elements then the user may be presented within the same options as described above in respect of FIGS. 5 to 8 with respect to its placement and/or re-positioning etc. as well as being presented with an option to associate the idea to an element by, for example, clicking it after selecting an option to associate. Within embodiments of the invention different elements within a template may have different formatting options associated with them such that when the idea dropped comprises text it is rendered in a format associated with that element using a methodology such as described within U.S. Patent Application 2020/0,097,302 entitled “Methods and Systems for Content Generation via Templates with Rules and Triggers.”

Now referring to FIG. 10 there are depicted first to third Snap Tool GUIs 1000A to 1000C respectively for the acquisition of electronic content, ideas, for subsequent rendering to a user within a queue, e.g. Queue 520 in FIG. 5, for addition to a mind map, e.g. MM 510 in FIG. 5. The “Snap Tool” to which first to third Snap Tool GUIs 1000A to 1000C being a content acquisition software application which a user may execute to acquire and send content to a mind mapping software application according to embodiments of the invention. Referring to first Snap Tool GUI 1000A the user is presented with a pop-up window with first to third Fields 1010 to 1030 which respectively comprise:
First Field 1010 wherein the user can select the type of “Snap” they are making to capture the idea, for example, text, graphics, URL, audiovisual content etc.;
Second Field 1020 wherein the user can add a topic; and
Third Field 1030 wherein the user can add notes.

Accordingly, referring to second Snap Tool GUI 1000B the user has added “Email Mark: into second Field 1020 to generate Modified Second Field 1040 and “Ask about hex colors” to third Field 1030 to generate Modified Third Field 1050. At this point the user can click “Send” wherein the idea they have generated is “sent” from the Snap Tool software application to their MMSW account so that when they next access the mind mapping software the idea appears in their queue. After clicking “Send” 1060 the user is presented with third Snap Tool GUI 1000C indicating the “Snap” was successfully sent and providing them with first and second option Buttons 1070 and 1080 respectively to either view their queue or send more “Snaps.” If the user selects first option Button 1070 then the mind mapping software (MMSW) may be launched such as described and depicted with respect to FIG. 5, for example, or alternatively wither a “light” version of the MMSW or a dedicated MMSW Queue application may be launched which renders only the queue to the user, which as will become evident in respect of embodiments of the invention may provide specific benefits to managing ideas with groups, with collaborators etc. where the “light” version of the MMSW or a dedicated MMSW Queue application allows the user to modify ideas, forward them to others, associate them with one or more mind maps, delete etc.

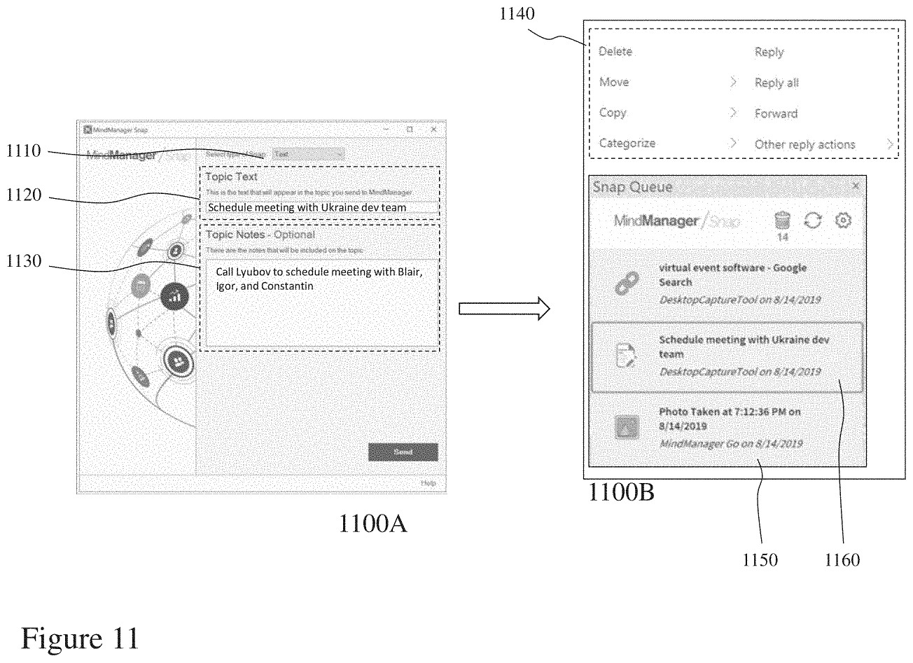

Accordingly, referring to FIG. 11 there is depicted a first GUI 1100A filled according to the user entering the data for the second Snap 540 as depicted in FIG. 5 where:
First Field 1110 is set to “Text”;
Second Field 1120 wherein the user has added the text “Schedule meeting with Ukraine dev team” as the topic; and
Third Field 1030 wherein the user has added “Call Lyubov to schedule meeting with Blair, Igor, and Constantin” as notes.

Accordingly, in second GUI 1100B the user has selected the option to view their queue, as discussed above with respect to third Snap Tool GUI 1000C wherein a dedicated MMSW Queue application is launched rendering the second GUI 1000B. For example, the dedicated MMSW Queue application may be launched rather than the full MMSW when the user selects this option from a mobile device or from within a remote session via a VM, for example. Within second GUI 1000B the Queue 1150 is rendered to the user including the Idea 1160 established from the first GUI 1100A. Also depicted is Menu 1140 which provides a series of options to the user with respect to a selected item in the Queue 1150, e.g. Idea 1160. As depicted the options within the Menu 1140 are “Delete”, “Move”, “Copy”, Categorize”, “Reply”, “Reply All”, “Forward” and “Other Reply Actions.” Many of these options within the Menu 1140 associated embodiments of the invention providing user with wider functions such as managing ideas with groups, sharing ideas with collaborators, receiving ideas from collaborators, etc. These including, for example, “Reply”, “Reply All”, “Forward” and “Other Reply Actions.” Other options such as “Move”, “Copy”, “Categorize” may allow the user to associate an idea with a specific mind map or replicate an idea to modify it slightly speeding up their entry of other associated ideas to their original idea etc.

Optionally, within first GUI 1100A the user may be provided with a Field wherein they can enter the identity of a mind map the idea should be associated with. This may, for example, be a drop down menu which lists all mind maps currently associated with the user either as originator, owner or collaborator, for example. A similar field may be provided within the second GUI 1100B such that the list of ideas presented to the user can be for all mind maps or for a specific mind map of which they are originator, owner, collaborator etc. Accordingly, the user's actions can be focused to a specific mind map to view their queue within the dedicated MMSW Queue application although it would be evident that such a queue filtering may be automatically applied within a full MMSW based upon the user's opening of a mind map or selectively applied if required allowing a user to associate an idea originally intended for another mind map to a current mind map either uniquely or through a similar option such as depicted in second GUI 1100B with options such as copy, move, categorize etc.

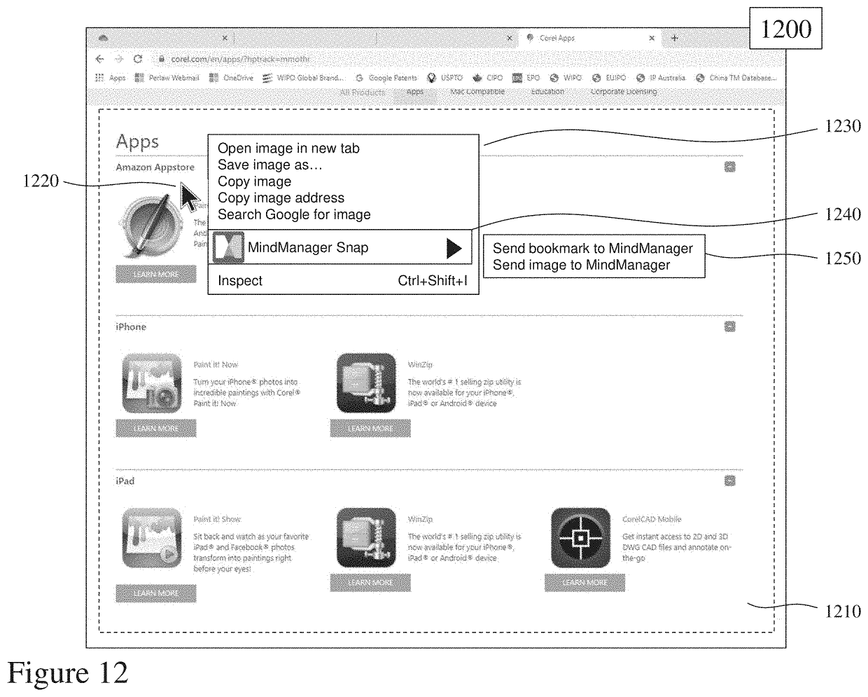

Now referring to FIG. 12 there is depicted an exemplary GUI 1200 for the acquisition of electronic content within a web browser through an extension of the web browser according to an embodiment of the invention. As depicted a user has navigated within a web browser to a web page 1210 wherein they wish to capture an element of the web page as an idea and send it to the queue for their MMSW. Accordingly, the user has navigated the Cursor 1220 over the item and right clicked a button on their mouse, or through an alternate selection technique as known in the art, resulting the Pop-Up 1230 being displayed which comprises a list of standard items populated by either the operating system of the computer the web browser is in execution upon or the web browser, for example, together with additional an additional element, Snap 1240, which is displayed as a result of an extension for the web browser, e.g. an extension for Google Chrome web browser (a Chrome extension as commonly known). Selection of the Snap 1240 element, for example by clicking or hovering the cursor over the element, results in Snap Pop-Up 1250 being rendered to the user which provides options for the user. As depicted the Snap Pop-Up 1250 allows the user to select either “Send bookmark to MindManager” or “Send image to MindManager.” Within embodiments of the invention the selection of either automatically sends the associated bookmark or selected image to the user's MMSW or it may trigger a further pop-up such as depicted in first GUI 1000A in FIG. 10 where the first Field 1010 is automatically set and the bookmark or image are inserted into the third Field 1030 leaving the user to enter topic text into the second Field 1020.

Within other embodiments of the invention the user may within the further pop-up triggered from the Snap Pop-Up 1250 or within the Snap Pop-Up 1250 be able to select one or more other aspects of the idea before it is sent including, but not limited to, which mind map the idea relates to, an identity of a collaborator or collaborators to whom the idea should be added to their queue(s), and an identity of a group of groups to whom the idea should be added to their queue(s). Accordingly, selecting electronic content and adding it to a queue within a MMSW application may be implemented, for example, through an extension to an existing software application, e.g. a web browser, or through a dedicated software application downloaded and installed on an electronic device of the user, e.g. a software application providing user interfaces such as described and depicted in FIG. 10, accessed from a software provider or repository of software applications such as Google™ Play Store or Apple™ App Store for example. Alternatively, the user can still add content by selecting, copying, pasting directly into the MMSW application, e.g. MindManager™, if they can have it open concurrently or alternatively into what is referred to commonly in the software industry as a “lite” or “mobile friendly” MMSW application, e.g. MindManager™ Go, allowing users to capture ideas and enter/distribute them to a queue (hereinafter referred to as a MMSW-lite application whilst a dedicated idea acquisition application such as described and depicted with respect to FIG. 10 is referred to as a Snap application).

Accordingly, embodiments of the invention may be implemented using a range of software tools and applications. For example, images, attachments, links, and notes may be sent to queue, MindManager™ Snap Queue, of the MMSW application MindManager using one or more of the following software applications:
“MindManager™ Go” mobile application for the Apple operating system, iOS;
“MindManager™ Go” mobile application for the Android open source platform and operating system;
“MindManager™ Snap” desktop application for Microsoft™ Windows;
“MindManager™ Snap” browser extension for Google™ Chrome.

These applications may also be accessed from electronic devices operating different operating systems to that of these applications (so called non-native applications) through one or more remote sessions established via one or more virtual machines with a remote access system. For example, such remote sessions being established and managed through Parallels™ Desktop for Mac (to access non-Apple™ iOS software applications upon an Apple™ iOS based device) or Parallels™ Desktop for Windows (to access non-Windows software applications upon a Microsoft™ Windows based device) for example, whilst the server side aspects of such remote systems, remote servers, virtual machines etc. may be managed through an application such as Parallels™ Remote Application Server.

It would be evident that the language of the GUIs presented to the user within the embodiments of the invention may be based upon a user preference or the language settings of the system upon which the application is in execution upon. However, the content acquired and sent as an idea may, in general, be within the original language displayed and/or used to create it although optionally the user may parse the content through a translator or exploit a language conversion feature of a web browser for example to translate content to a preferred language.

Within embodiments of the invention a MMSW application, a MMSW-lite application, and/or a Snap application may provide a user with some or all of the following interactive features with respect to sending electronic content to a queue, e.g. a MindManager™ Snap Queue, where other features not listed below may also be provided:
Send Content;
Send Topic Text;
Send Image;
Send Link;
Send Note; and
Send Attachment.

Within embodiments of the invention a MMSW application and/or a MMSW-lite application may provide a user with some or all of the following interactive features with respect to ideas/items/electronic content within a queue, e.g. a MindManager™ Snap Queue, where other features not listed below may also be provided:
View content type;
Filter and/or sort by content type;
View content source;
Filter and/or sort by content source;
Search content;
Select and drag-drop a single item into a mind map;
Select and drag-drop multiple items into a mind map;
Refresh;
View “trashed” items (where items deleted may be stored for a predetermined period of time, e.g. 24 hours, before permanently deletion);
Option to toggle trash on or off when dragging-dropping items; and
Option to “Trash All” items in the queue.

Within embodiments of the invention a MMSW application, a MMSW-lite application, browser extension and/or a Snap application provides a user with the ability to capture electronic content, for example from the Internet or their electronic device, and send it to a queue within a MMSW application for subsequent use within a mind map. The Snap application and/or browser extension allow the user to acquire content even when a MMSW application or MMSW-lite application is not in execution so that the user can capture content on a wider range of PEDs, FEDs, Wearable Devices without being limited to the devices ability to execute and support the MMSW application and/or MMSW-lite application. Accordingly, the MMSW application, a MMSW-lite application, browser extension and/or a Snap application allow a user to capture content in a wide range of scenarios.

For example, for content upon a desktop the user may perform the following sequence of steps with respect to employing a Snap application:
Step 1: Launch the installed Snap Application via either step 1A or step 1B; (e.g. via
   Step 1A: Press a key sequence (e.g. CTRL+ALT+M for MindManager Snap);
   Step 1B: From taskbar (e.g. Windows taskbar) click Start>Programs>MMSW Application (e.g. MindManager 2020)>MMSW Snap Application (e.g. MindManager Snap);
Step 2: Select one of the following options in the select type of Snap drop-down (e.g. drop-down from selecting first Field 1010 in FIG. 10);
   Option 2A: Text—type or select text to appear in the topic in the Topic Text field (e.g. second Field 1020 in FIG. 10);
   Option 2B: Bookmark—copy a URL in a browser and paste it in a Topic Link field or alternatively the user can type the text to appear in the topic in the Topic Text field;
   Option 2C: Attachment—where the user then selects a button “Select File” to navigate to the file and then click another button “Open” or the user can type the text to appear in the topic in the Topic Text field;
Step 3: (Optional) The user can add a topic note in the Topic Note field (e.g. third Field 1030 in FIG. 10);
Step 4: Click Send.

For example, for content upon a desktop the user may perform the following sequence of steps with respect to employing a browser application (e.g. within a Google™ Chrome browser):
Step 1: Capture the content by performing one of steps 1A to 1C;
   Step 1A: To capture a URL, right-click anywhere on the web page, and choose the options within the pop-up menu(s) of MindManager Snap>Send bookmark to MindManager wherein the web page URL appears in a Topic Link field or the user can type the text to appear m the topic in the Topic Text field;
   Step 1B: To capture an image, right-click the image, and choose the options within the pop-up menu(s) of MindManager Snap>Send image to MindManager, or the user can type the text to appear m the topic in the Topic Text field;
   Step 1C: To capture text on a web page, select the text, and choose the options within the pop-up menu(s) of MindManager Snap>Send selection to MindManager and the selected text appears in the Topic Text field or the user can also add a topic note in the Topic Note field;
Step 2: Click Send

For example, for content acquisition using a MMSW-lite application, such as MindManager™ Go for example, the user may perform the following sequence of steps:
Step 1: Within a “Snap” area perform one of steps 1A to 1C respectively:
   Step 1A: To capture an image employ the camera within the electronic device the MMSW-lite is installed upon and, tap an icon rendered to the user (e.g. an icon of a camera);
   Step 1B: To capture an image stored on the electronic device the MMSW-lite is installed upon the user taps a different icon (e.g. an icon of an image) and selects the image from the gallery of images stored upon the electronic device;
   Step 1C: To send a text note the user taps another different icon (e.g. an icon of a pen or pencil) and types the text;
Step 2: Click send

For example, for an item within the queue of an MMSW application or a MMSW-lite application the user may perform the following steps to insert content within a mind map:
Step 1: Perform either Step 1A or Step 1B:
   Step 1A: On an Insert tab of the application, click a button, e.g. MindManager Snap;
   Step 1B: Within the Status Bar of the application, click a Task Panes button and then Snap Queue (e.g. Snap Queue 520 in FIG. 5);
Step 2: Within the rendered Snap Queue pane, e.g. drag a piece of captured content onto the map to insert it as a new topic. When the user drags a piece of captured content onto an existing topic, it is inserted as a sub-topic.

The insertion of the item of electronic content from the queue may be as a new topic or it may be inserted into an existing topic. Within embodiments of the invention after insertion into a mind map the item may be automatically deleted from the queue or alternatively it may remain for use by the user within another mind map until it is deleted by the user.

For example, for an item within the queue of an MMSW application or a MMSW-lite application the user may perform the following steps to clear a Snap queue:
Step 1: Within the Snap Queue pane (e.g. Snap Queue 520 in FIG. 5), click the Options button;
Step 2: Click Trash All.

For example, for an item within the queue of an MMSW application or a MMSW-lite application the user may perform the following steps to restore it to a Snap queue:
Step 1: Within the Snap Queue pane (e.g. Snap Queue 520 in FIG. 5), click the Open Trash button;
Step 2: Click the Restore button after selecting the item(s) of content within the rendered list of trashed items that the user wishes to reuse.

Within the description above the primary sequence(s), flow(s), action(s) etc. have been described with respect to a user selecting an item of content, sending it to an MMSW application queue, and employing the item of content within a mind map. However, as noted above items of content may not only be limited to a single user selecting content for their own use but the methods and flows described and depicted with respect to FIGS. 5 to 12 respectively may also be applied with respect to managing ideas (items of content) with other users within a group or groups, sharing ideas with a collaborator or collaborators, and receiving ideas from a collaborator or collaborators. Accordingly, within embodiments of the invention the user may be able to access multiple queues and/or apply filters to a single queue or multiple queues where these features can be supported by a MMSW application, a MMSW-lite application, browser extension and/or a Snap application.

For example, a first embodiment of such collaboration features may include what the inventors refer to as “N:1 Snap” capabilities which provides additional capabilities including, but are not limited to, a user inviting another user or users to send items of content (Snap items) to the user's personal queue.

For example, such a process may exploit a process with an initial invitation from the user to the other user wherein the other user will need to accept the user's invitation for the other user to have the ability to send items of content to the user. Once the other user accepts then when choosing to Snap an item they can either Snap it to themselves or to the Snap queue of the user where the queue they will distribute the item of content to (Snap it to) may be selected by the user from a dropdown list while generating the Snap. Each new user the other user accepts an invitation from is added to the drop down list. Accordingly, this drop down list apart from themselves lists other users the user can contribute a Snap item to (these other users being also known as collaborators or contributors). Optionally, this process is reciprocal such that when the other user accepts the user's offer then the other user is added to the drop list for the user or within other embodiments of the invention this process is unidirectional such that the user must receive an invite from the other user to send them Snaps.

Within embodiments of the invention even though multiple users may access a single mind map these other contributors may not see the user's own Snap queue. Hence, a user only sees and controls the information within their Snap queue and the contributor(s) only get to send the user information (Snaps). A user can uninvite contributors when they wish as well as contributors can remove themselves from being a contributor at any time to a specific user. Accordingly, this allows a user when working on a project to manage receiving items of content (Snaps) from other users who may or may not be involved and want or need them to send the user updates, information, ideas, etc.

For example, a second embodiment of such collaboration features may include what the inventors refer to as “Team Snap” capabilities which provides additional capabilities including, but are not limited to, allowing a user to create new queues, referred to as team queues, inviting another user or users to the team and allowing the team members to each view items within the team queue.

For example, such a process may exploit a process with a user initially creates a new queue and defines it as a team queue, as the MMSW may support multiple personal queues for a user within other embodiments of the invention. Subsequently, the user sends an invitation from the user to the other user(s) who they want to have access to the team queue wherein the other user will need to accept the user's invitation for them to have access to the team queue either to view items of content within it or to send items of content to it.

All contributors to a team queue can send (Snap) items of content to the team queue, similar to the N:1 scenario outline above, but now each contributor will be able to see, control (e.g. delete, etc.) the items of the content within the shared queue. Further, each contributor accessing the team queue can add the item of content to a mind map they have permission to edit or write or amend. It would be evident that a user can be a member of more than one team queue together with having their own personal queue. Accordingly, additional filtering options may be provided to a user allowing the user to filter items of content, for example, by:
what they have added;
items added by a specific contributor;
items added by a selected set of specific contributors (who are not members of a common team for example);
items added by contributors of a specific team or set of teams.

Within embodiments of the invention the MMSW application or MMSW-lite application may be, for example, part of a software as a service (SaaS) offering or one or more of cloud computing, infrastructure as a service (IaaS), platform as a service (PaaS), desktop as a service (DaaS), managed software as a service (MSaaS), mobile backend as a service (MBaaS), datacenter as a service (DCaaS), and information technology management as a service (ITMaaS), for example. The items of content acquired by a user and sent to a queue may be stored within one or more servers associated with the MMSW application or MMSW-lite application and which are retrieved and stored upon the user's local device, e.g. Client Device 220 in FIG. 2, when the user accesses the MMSW application or MMSW-lite application wherein when added to a mind map the new mind map may be locally and/or remotely stored having been locally and/or remote retrieved for the user to add the item(s) of content from the queue. Alternatively, the entire process may be remotely stored and performed either through the MMSW application or MMSW-lite application directly or through a virtual machine executing the MMSW application or MMSW-lite application within a remote session such that the items of content/queues/mind maps etc. are all stored within remove servers.

Accordingly, the separation between acquisition of an idea and addition of the idea to a mind map or it being rendered within a mind mapping software application is increased such that, for example, the scenarios including, but not limited to, those listed below may be implemented:
a first user may be exploiting a first software application, e.g. a MMSW application, a MMSW-lite application, browser extension and/or a Snap application, within a first remote session upon a first virtual machine to capture an idea whilst a second user may employ the idea within a MMSW application within a second remote session with a second software application upon a second virtual machine upon the same electronic device, e.g. Client Device 220 in FIG. 2A;
a first user may be exploiting a first software application, e.g. a MMSW application, a MMSW-lite application, browser extension and/or a Snap application, within a first remote session upon a first virtual machine upon a first electronic device, e.g. Mobile Device 210 in FIG. 2A, to capture an idea whilst a second user within a second remote session with a MMSW application upon a second virtual machine upon a second electronic device, e.g. Client Device 220 in FIG. 2A, embeds the captured idea within a mind map;
a first user may be exploiting a first software application, e.g. a MMSW application, a MMSW-lite application, browser extension and/or a Snap application, upon a first electronic device to capture an idea whilst a second user may employ the idea within a MMSW application upon the same electronic device, e.g. one of first and second Client Devices 220A and 220B respectively in FIG. 2B;
a first user may be exploiting a first software application, e.g. a MMSW application, a MMSW-lite application, browser extension and/or a Snap application, upon a first electronic device to capture an idea whilst a second user may employ the idea within a MMSW application upon the same electronic device, e.g. one of first to third Client Devices 210A to 210C respectively in FIG. 2B;
a first user may be exploiting a first software application, e.g. a MMSW application, a MMSW-lite application, browser extension and/or a Snap application, upon a first electronic device, e.g. one of first and second Client Devices 220A and 220B respectively in FIG. 2B, to capture an idea whilst a second user with a MMSW application upon a second electronic device, e.g. the other of first and second Client Devices 220A and 220B respectively in FIG. 2B, embeds the captured idea within a mind map;
a first user may be exploiting a first software application, e.g. a MMSW application, a MMSW-lite application, browser extension and/or a Snap application, upon a first electronic device, e.g. one of first to third Client Devices 210A to 210C respectively in FIG. 2B, to capture an idea whilst a second user with a MMSW application upon a second electronic device, e.g. another of first to third Client Devices 210A to 210C respectively in FIG. 2B, embeds the captured idea within a mind map;
a first user may be exploiting a first software application, e.g. a MMSW application, a MMSW-lite application, browser extension and/or a Snap application, upon a first electronic device, e.g. one of first and second Client Devices 220A and 220B respectively in FIG. 2B, to capture an idea whilst a second user with a MMSW application upon a second electronic device, e.g. one of first to third Client Devices 210A to 210C respectively in FIG. 2B, embeds the captured idea within a mind map;
a first user may be exploiting a first software application, e.g. a MMSW application, a MMSW-lite application, browser extension and/or a Snap application, upon a first electronic device, e.g. one of first to third Client Devices 210A to 210C respectively in FIG. 2B, to capture an idea whilst a second user with a MMSW application upon a second electronic device, e.g. one of first and second Client Devices 220A and 220B respectively in FIG. 2B, embeds the captured idea within a mind map.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other mediums capable of storing, containing, or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
establishing selection of an item of content by a user;
transmitting the selected item of content to a memory for storage;
rendering the item of content within a mind mapping software application as an item in a queue of items;
adding the item of content to a mind map rendered within the mind mapping software application in dependence upon a drag-and-drop action by the user with respect to item of content placing the item of content within a user defined position within the mind map and the application of a subset of a plurality of rules of the mind mapping software application.

2. The method according to claim 1, wherein
a first rule of the plurality of rules relates to how to add the item of content to the mind map based upon other elements of the mind map within the vicinity of the user defined position;
a second rule of the plurality of rules relates to how to add the item of content to the mind map based upon the user defined position overlapping an existing rendered element of the mind map; and
a third rule of the plurality of rules relates to how to add the item of content to the mind map based upon a type of the item of content.

3. A method comprising:
providing a first computer system coupled to a communications network comprising a first microprocessor, the first microprocessor executing first code stored within a first memory to provide a first user with a first software application rendering first graphical user interfaces (GUIs) to the user and accepting user input via first haptic interfaces of the first computer system;
providing a second computer system coupled to the communications network comprising a second microprocessor, the second microprocessor executing second code stored within a second memory to provide a second user with a second software application rendering second graphical user interfaces (GUIs) to the user and accepting user input via second haptic interfaces of the second computer system;
receiving upon the first computer system first inputs from the first user via the first haptic interfaces relating to accessing the first software application;
rendering upon the first computer system a first GUI comprising a plurality of fields;
receiving upon the first computer system second inputs from the first user via the first haptic interfaces relating to identifying a type of electronic content within a first field of the plurality of fields;
receiving upon the first computer system third inputs from the first user via the first haptic interfaces relating to the selection of an item of electronic content rendered to the user within a third GUI associated with a third software application;
associating the item of electronic content with a second field of the plurality of fields in dependence upon the type of electronic content;
receiving upon the first computer system fourth inputs from the first user via the first haptic interfaces relating to additional data to be transmitted with the item of content;
associating the additional data within one or more third fields of the plurality of fields;
combining the type of electronic content, the item of electronic content and the additional data together as a mind map item;
transmitting to a third memory accessible to the first computer system;
receiving upon the second computer system fifth inputs from the second user via the second haptic interfaces relating to accessing the second software application;
rendering to the second user upon the second computer system a second GUI comprising a first portion for rendering a mind map selected by the second user and a second portion comprising the mind map item;
receiving upon the second computer system sixth inputs from the second user via the second haptic interfaces relating to selection of the mind map item;
receiving upon the second computer system seventh inputs from the second user via the second haptic interfaces relating to movement of a cursor rendered to the user within first portion of the second GUI selection to which the mind map item is linked;
receiving upon the second computer system eighth inputs from the second user via the second haptic interfaces relating to the cursor within the first portion of the second GUI releasing the mind map item at a user defined position;
adding the item of content to the mind map rendered within the first portion of the second GUI in dependence upon the user defined position within the mind map and the application of a subset of a plurality of rules of the mind mapping software application.

4. The method according to claim 3, wherein
a first rule of the plurality of rules relates to how to add the item of content to the mind map based upon other elements of the mind map within the vicinity of the user defined position;
a second rule of the plurality of rules relates to how to add the item of content to the mind map based upon the user defined position overlapping an existing rendered element of the mind map; and
a third rule of the plurality of rules relates to how to add the item of content to the mind map based upon a type of the item of content.

5. The method according to claim 3, wherein
the first user and the second user are the same user.

6. The method according to claim 3, wherein
the first user was previously invited by the second user to provide items of content of which the item of content is one to the second user;
the first user accepted the second user's invitation; and
the first user cannot view the item of content within the second portion of the second software application.

7. The method according to claim 3, wherein
the first user and the second user are members of a group; and
the second user can view the item of content with the second portion of the second GUI within the second software application; and
the first user can view the item of content within another second portion of another second GUI within another instance of the second software application.

8. The method according to claim 3, wherein
the item of content is one of an item of text, a uniform resource locator, and an image.

9. A method comprising:
acquiring electronic content within a first software application upon a first electronic device;
storing the electronic content within a memory accessible to the first software application and the second software application; and
presenting the electronic content within a second software application upon a second electronic device.

10. The method according to claim 9, wherein
acquisition of the electronic content within the first software application upon the first electronic device is performed by a first user;
storing the electronic content within the memory comprises transmitting the electronic content to a remote server; and
presenting the electronic content within the second software application upon the second electronic device comprises:
receiving from a second user a request to open the second software application upon the second electronic device;
opening the second software application upon the second electronic device;
automatically retrieving from the remote server the electronic content;
retrieving and opening a mind map within the second software application in dependence upon a selection of a mind map by the second user;
rendering the electronic content within a region of a graphical user interface (GUI) of the second software application where the region is different to another region of the GUI rendering the mind map; and
receiving an indication of a drag and drop operation within the GUI with respect to the electronic content wherein once dropped the electronic content is automatically added to the mind map;
the second software application is a mind mapping software application;
an aspect of the automatic addition of the electronic content to the mind map is established in dependence upon where the electronic content is dropped within the mind map; and
the automatic retrieval of the electronic content is performed either before the user opens the mind map or after the mind map is opened and is performed independent of which mind map the second user opens.

11. The method according to claim 9, wherein
acquisition of the electronic content within the first software application upon the first electronic device is performed by a first user;
storing the electronic content within the memory comprises transmitting the electronic content to a remote server; and
presenting the electronic content within the second software application upon the second electronic device comprises:
receiving from a second user a request to open the second software application upon the second electronic device;
opening the second software application upon the second electronic device;
retrieving and opening a mind map within the second software application in dependence upon a selection of a mind map by the second user;
determining whether the electronic content has metadata associating it with either the second user or the mind map;
upon a positive determination that the electronic content has metadata associating it with either the second user automatically retrieving from the remote server the electronic content independent of the mind map opened by the second user;
upon a positive determination that the electronic content has metadata associating it with the mind map automatically retrieving from the remote server the electronic content;
upon a negative determination that the electronic content does not have metadata associating it with either the second user or the mind map the second software application proceeds without automatically retrieving from the remote server the electronic content;
rendering the electronic content within a region of a graphical user interface (GUI) of the second software application where the region is different to another region of the GUI rendering the mind map; and
receiving an indication of a drag and drop operation within the GUI with respect to the electronic content wherein once dropped the electronic content is automatically added to the mind map;
the second software application is a mind mapping software application; and
an aspect of the automatic addition of the electronic content to the mind map is established in dependence upon where the electronic content is dropped within the mind map.
